(19) United States
(12) Patent Application Publication
(10) Pub. No.: US 2007/0242971 A1
(43) Pub. Date: Oct. 18, 2007

(54) Image forming apparatus and image forming method

(76) Inventor: Hirofumi Goto, Kanagawa (JP)

Correspondence Address: MORGAN LEWIS & BOCKIUS LLP, 1111 PENNSYLVANIA AVENUE NW, WASHINGTON, DC, 20004, US

(21) Appl. No.: 11/798,256

(22) Filed: May 11, 2007

Related U.S. Application Data
(62) Division of application No. 11/216,177, filed on Sep. 1, 2005.

(30) Foreign Application Priority Data
Mar. 11, 2005 (JP) P2005-069745

(51) Int. Cl. G03G 15/00; G03G 15/01; G03G 15/16

(52) U.S. Cl. 399/82; 399/297; 399/299; 399/302

(57) ABSTRACT

An image forming apparatus includes: an intermediate transfer mechanism that carries a toner image on an intermediate transfer body and then transfer the toner image onto a recording medium; a direct transfer mechanism that directly transfers a toner image onto a recording medium; and a controller that makes control for printing using the direct transfer mechanism alone or using both the intermediate transfer mechanism and the direct transfer mechanism, depending on the type of an image to be printed.

This application is a divisional of U.S. application Ser. No. 11/216,177, filed Sep. 1, 2005. The entire contents of the application are incorporated herein by reference.

### BACKGROUND OF THE INVENTION

1. Field of the Invention

The present invention relates to image forming apparatus such as a printer and a copier, and in particular to image forming apparatus capable of forming a color image.

2. Description of the Related Art

An image forming apparatus such as a copier and a printer employs, for example, a tandem-type intermediate transfer system in forming a full-color image on a recording medium (for example, refer to JP-A-2001-117384). In image forming apparatus employing the intermediate transfer system, for example, image forming units of yellow (Y), magenta (M), cyan (C) and black (K) are arranged in parallel with an intermediate transfer belt stretched and laid over a plurality of rolls. Toner images of these colors Y, M, C, K are transferred onto the intermediate transfer belt in a multiple manner and collectively transferred (secondarily transferred) onto a recording medium in a so-called secondary transfer section.

As a related art technology, there exists image forming apparatus of an intermediate transfer system using a system other than a tandem type (for example, refer to JP-A-2004-191771). According to the method described in JP-A-2004-191771, an intermediate transfer belt makes four turns for example so that toner images are superimposed one after another onto the intermediate transfer belt to perform primary transfer. After that, the color toner images transferred in a multiple manner onto this intermediate transfer belt are collectively transferred (secondarily transferred) onto a recording medium in a so-called secondary transfer section.

### SUMMARY OF THE INVENTION

However, the intermediate transfer system mentioned above is accompanied by such problems as described below.

In the tandem-type image forming apparatus described in JP-A-2001-117384, the perimeter length of the intermediate transfer belt is increased, which increases the overall cost of the image forming apparatus. In other words, the cost of image forming apparatus is influenced by material cost as well as productivity. Accommodating the size (diameter) of an intermediate transfer belt within the size of a mold that could enhance the productivity will dramatically reduce the cost of the image forming apparatus.

In a so-called monochrome mode where no color images are generated on the tandem-type image forming apparatus, for example, it is preferable to place a photoreceptor drum apart from an intermediate transfer belt in order to prevent the lift of an image forming unit (engine) for other than the black color (K) from being shortened due to abrasion. However, to place the photoreceptor drum apart from the intermediate transfer belt, a predetermined retractor mechanism is needed, which complicates the apparatus design.

Further, in an intermediate transfer unit composed of Y, M, C and K image forming units arranged in parallel, the intermediate transfer unit is large and heavy because of the number of image forming units. This substantially lowers efficiency and increases maintenance of the intermediate transfer unit. Moreover, when a color image forming unit has to be replaced with a new one, the machine does not operate until the replacement procedure is over. For example, a user wishing to print or make a monochrome copy on the machine must wait for a predetermined period.

The intermediate transfer belt system described in JP-A-2001-117384 or JP-A-2004-191771, the black color (K) undergoes two transfers, a primary transfer and a secondary transfer, so that the corresponding transfer efficiency is worse than that of a monochrome image forming apparatus. In particular, the black color (K) toner has a post-transfer charge that is likely to show a broad range of polarity (a phenomenon in which the negative polarity is weakened to let some polarity shift to the positive side). As a result, so-called retransfer is likely to occur, that is, a phenomenon that toner transferred onto a recording medium tends to move to an intermediate transfer belt.

In the intermediate transfer system, yellow (Y), magenta (M) and cyan (C) undergo primary transfers to form a multiple image on an intermediate transfer belt, then undergo retransfer in the image forming unit (engine) of the black color (K). This reduces the efficiency of multiple primary transfer.

Further, the secondary transfer section is set at a high voltage to allow multiple transfer onto a recording medium, with voltage setting tailored to multiple transfer. Thus, toner having a small charge volume such as the black color (K) undergoes an excessive pressure and an excessive pressure in the secondary transfer section, which is likely to generate a missing spot in a transferred image.

A secondary transfer voltage must be typically high enough to transfer a multiple colors of Y, M, C. However, this voltage value is often excessive for a single-color image in a full-color image, in particular a highlight pattern of black (K). As a result, graininess is increased especially in a high-temperature, high-humidity environment, while a discharge-type dropout called a micro white spot (WS) is likely to occur in a low-temperature, low-humidity environment.

The invention has been has been made in view of the above circumstances and provides an image forming apparatus and an image forming method. A major object of the invention is to secure high transfer efficiency in forming a single-color image on an apparatus capable of forming an image of a plurality of colors.

Another object of the invention is to provide a compact and lightweight apparatus that is capable of forming an image of a plurality of colors and that features low cost and easy maintenance.

A further object of the invention is to dramatically increase the service life of a color image forming unit of the apparatus.

According to an embodiment of this invention, an image forming apparatus includes: an intermediate transfer mechanism that carries a toner image on an intermediate transfer body to transfer the toner image onto a recording medium; a direct transfer mechanism that directly transfers a toner image onto a recording medium; and a controller that makes control for printing using the direct transfer mechanism alone or using both the intermediate transfer mechanism and the direct transfer mechanism, depending on the type of an image to be printed.

The invention may provide an image forming apparatus including: an intermediate transfer mechanism that carries a toner image on an intermediate transfer body and then transfers the toner image onto a recording medium; a direct transfer mechanism that directly transfers a toner image onto a recording medium; wherein the image forming apparatus outputs a single image print by using both the intermediate transfer mechanism and the direct transfer mechanism.

The invention may provide an image forming apparatus including: a first transfer section that transfers an image of a plurality of colors onto a carrier and then collectively transfers the image of the plurality of colors onto a recording medium; a second transfer section that transfers a single-color image onto the recording medium; a first conveying path that conveys the recording medium via the first transfer section and the second transfer section and that forms an image onto the recording medium; and a second conveying path that conveys the recording medium via the second transfer section and not the first transfer section and that forms an image onto the recording medium.

The invention may provide an image forming method, including: determining from input image data whether a color image or a monochrome image is to be produced; controlling operation so that a recording medium is conveyed via a first image forming unit for forming a black (K) image without passing through a second image forming unit for forming an image including a plurality of colors, when it is determined that the monochrome image is to be produced; and controlling operation so that the recording medium is conveyed via the first image forming unit and the second image forming unit, when it is determined that the image is a color image.

### BRIEF DESCRIPTION OF THE DRAWINGS

The present invention may be more readily described with reference to the accompanying drawings:

FIG. 1 shows the overall configuration of image forming apparatus according to an embodiment of the invention;

FIG. 2 explains conveyance of a recording medium assumed when a full-color image is formed;

FIG. 3 explains conveyance of a recording medium assumed when a monochrome image is formed;

FIG. 4 is a flowchart of the processing for image formation and conveyance of a recording member by way of a controller; and

FIG. 5 shows an example where this embodiment is applied to image forming apparatus of the intermediate transfer system other than the tandem type.

### DETAILED DESCRIPTION OF THE EMBODIMENTS

An embodiment of the invention is described below referring to the attached drawings.

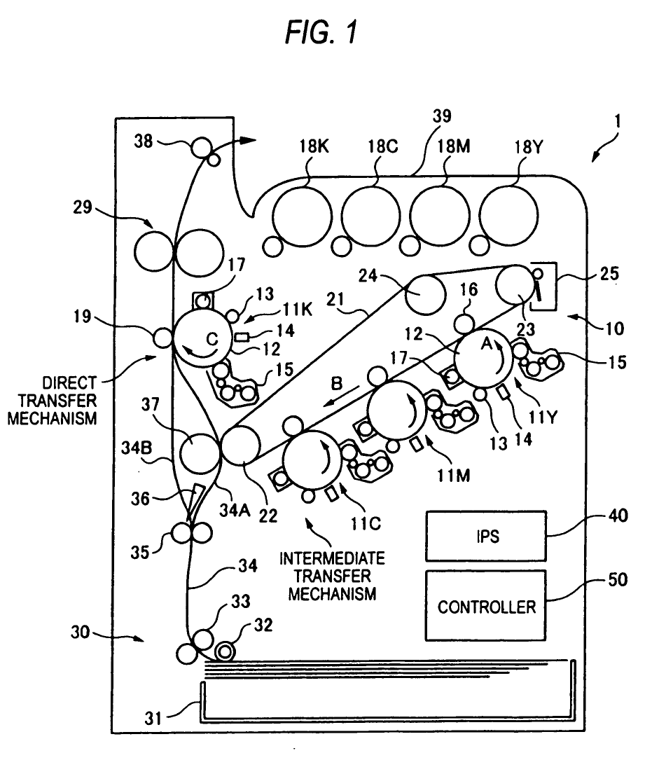

FIG. 1 shows the overall configuration of image forming apparatus according to an embodiment of the invention. The image forming apparatus shown in FIG. 1 comprises, on a main body 1, an image process system 10 for forming an image in accordance with the gradation data of each color and a paper conveying system 30 for conveying a recording medium (paper, sheets). The image forming apparatus further comprises, for example, an image processing system (IPS) 40 connected to a personal computer or a scanner unit (not shown), the IPS performing predetermined image processing on the image data received therefrom. Further, the image forming apparatus comprises a controller 50 for controlling the image process system 10 and the paper conveying system 30.

The image process system 10 in this embodiment comprises an intermediate transfer mechanism and a direct transfer mechanism. The intermediate transfer mechanism includes an intermediate transfer belt 21 and three image forming units 11Y, 11M, 11C of three colors, Yellow (Y), Magenta (M) and Cyan (C) arranged in parallel with predetermined spacing while facing the intermediate transfer belt 21. In this embodiment, the units constituting the intermediate transfer mechanism are generically called a “color image forming unit”. The direct transfer mechanism includes a K image forming unit 11K as an image forming unit of the color black (K) and a transfer roll 19 for transferring a black toner image formed in the K image forming unit 11K onto a recording medium.

The three image forming units 11Y, 11M, 11C included in the color image forming unit that constitutes an intermediate transfer mechanism and employs an intermediate transfer system each have similar elements for executing an image forming process. While reference numbers are assigned to the sections of the image forming unit 11Y in FIG. 1, these reference numbers also designate the sections of the remaining image forming units 11M, 11C. To be more specific, the image forming units 11Y, 11M, 11C each include a photoreceptor drum 12 as an image carrier for carrying a toner image; an electrifier 13 for electrifying the photoreceptor drum 12 by using an electrifying roll; an exposure device 14 for irradiating light onto the photoreceptor drum 12 electrified by the electrifier 13 to form an electrostatic latent image on the photoreceptor drum 12; a developing device 15 for developing with toner, by way of the exposure device 14, the electrostatic latent image formed on the photoreceptor drum 12; a primary transfer roll 16 disposed facing the photoreceptor drum 12 across the intermediate transfer belt 21, the primary transfer roll 16 transferring the toner image developed on the photoreceptor drum 12 onto the intermediate transfer belt 21; and a drum cleaner 17 for removing residual toner on the photoreceptor drum 12 after transfer is complete. The exposure device 14 is formed by an LED print head (LPH) comprising for example an LED array and a lens array. The photoreceptor drum 12 is rotated in the direction of an arrow A at a section the photoreceptor drum 12 faces the intermediate transfer belt 21 while aligned with the travel direction of the intermediate transfer belt 21 (direction of an arrow B). Further, toner cartridges 18Y, 18M, 18C, 18K are provided for supplying toner of each color to the image forming units 11Y, 11M, 11C and the K image forming unit 11K.

The color image forming unit includes: a backup roll 22 for secondarily transferring color toner images superimposed on each other onto a recording medium; a drive roll 23 for driving the intermediate transfer belt 21; a tension roll 24 for providing tension to the intermediate transfer belt 21; and a belt cleaner for removing residual toner on the intermediate transfer belt 21. The intermediate transfer belt 21 is laid over the backup roll 22, the drive roll 23 and the tension roll 24 under tension. The intermediate transfer belt 21 is driven at a predetermined speed in the direction of the arrow B in FIG. 1 by the drive roll 23 rotated by a dedicated drive motor (not shown) which maintains speed within a narrow range. The intermediate transfer belt 21 is made of a belt material (rubber or resin) resistant to build-up of static charge, the material subjected to controlled resistance.

The K image forming unit 11K has similar elements to the three color image forming units 11Y, 11M, 11C. That is, the K image forming unit 11K includes a photoreceptor drum 12, an electrifier 13, an exposure device 14, a developing device 15, and a drum cleaner 17. The K image forming unit 11K rotates in the direction of an arrow C in the figure to execute an image forming process. Note that the photoreceptor drum of the K image forming unit 11K does not come in contact with the intermediate transfer belt 21 and the unit includes a transfer roll 19 instead of a primary transfer roll 16. With this configuration, a toner image carried by the photoreceptor drum 12 is not transferred onto the intermediate transfer belt 21 by way of the primary transfer roll 16 but directly transferred onto a recording medium by the transfer roll 19.

The main body 1 includes a fixing device 29 for fixing onto a recording medium, by using heat and pressure, a toner image transferred in a multiple manner or transferred onto a recording medium by an intermediate transfer mechanism and/or a direct transfer mechanism.

The paper conveying system 30 includes a paper feed tray 31 for loading and feeding a recording medium on which an image is recorded, a nudger roll for picking and feeding a recording medium from the paper feed tray 31, and a feed roll 33 for separating the recording medium supplied from the nudger roll 32 into sheets and conveying each sheet of paper. The paper conveying system 30 also includes a conveying path 34 for further conveying the recording medium conveyed by the feed roll 33 toward an image transfer section. On the conveying path 34 are provided various paper feed mechanisms. For example, there is a resist roll 35 for temporarily stopping the recording medium conveyed on the conveying path 34 and conveying, with precise timing, the recording medium toward the transfer position (secondary transfer position (first transfer section) or direct transfer position (second transfer section)) of the toner image, a switching gate 36 for switching between the conveying paths (first conveying path 34A or second conveying path 34B) for the recording medium conveyed by the resist roll 35, and a secondary transfer roll 37 disposed at the secondary transfer position. The secondary transfer roll 37 is arranged facing the backup roll 22 and presses a recording medium being conveyed and the intermediate transfer belt 21 against the backup roll 22 while applying a transfer electric field (not shown) to secondarily transfer a toner image onto the recording medium. Further, the paper conveying system 30 includes an ejecting roll 38 for ejecting a recording medium on which a toner image is fixed by the fixing device 29 out of the main body 1, and an ejecting tray for loading the recording medium ejected by the ejecting roll 38. The first conveying path 34A forms a conveying path for conveying a recording medium via an intermediate transfer mechanism and a direct transfer mechanism. The second conveying path 34B offers a conveying path for conveying a recording medium via a direct transfer mechanism, and not an intermediate transfer mechanism.

Operation of the image forming apparatus according to this embodiment will be described referring to FIG. 1. For example, a color material reflected light image of a manuscript read by a scanner unit (not shown) or color material image data formed by a personal computer (not shown) is input to an IPS 40 as 8-bit reflectance data of R (red), G (green), B (blue) respectively, for example. The IPS 40 performs predetermined image processing such as various image edit processes including shading correction, dislocation correction, lightness/color space conversion, gamma correction, frame deletion and color edit, and edit on the input reflectance data. The image data that has undergone image processing is converted to color material gradation data of four colors, yellow (Y), magenta (M), cyan (C) and black (K), and input to the exposure device 14 of each image forming unit 11Y, 11M, 11C constituting an intermediate transfer mechanism and the exposure device 14 of the K image forming unit 11K constituting a direct transfer mechanism. In case the input image data is monochrome image data, only the K image forming unit 11K that constitutes the direct transfer mechanism operates.

When a full-color image is formed, the image forming units 11Y, 11M, 11C constituting a color image forming unit has a photoreceptor drum 12 electrified at a predetermined potential by the electrifier 13. The exposure device 14 of each image forming unit 11Y, 11M, 11C causes a corresponding LED to emit light in accordance with the color material gradation data input from the IPS 40 and irradiates the light onto the photoreceptor drum 12 of the image forming units 11Y, 11M, 11C via a lens array. The photoreceptor drum 12 of each image forming unit 11Y, 11M, 11C has an electrified surface exposed to light to form an electrostatic latent image. The formed electrostatic latent image is developed as toner images of yellow (Y), magenta (M) and cyan (C) in the developing device 15 for each image forming unit 11Y, 11M, 11C. The toner image developed on each photoreceptor drum 12 is sequentially transferred onto the intermediate transfer belt 21, resulting in multiple transfer of toner images of yellow (Y), magenta (M) and cyan (C). Residual toner on the photoreceptor drum 12 of each image forming unit 11Y, 11M, 11C after transfer is cleaned by the drum cleaner 17.

In the paper conveying system 30, the nudger roll 32 rotates with the timing of image formation and a recording medium of a predetermined size is fed from the paper feed tray 31. The recording medium separated into sheets by the feed roll 33 is conveyed to the resist roll 35 via the conveying path 34 and temporarily stopped. After that, the resist roll 35 rotates with the travel timing of the intermediate transfer belt 21 on which a toner image is formed.

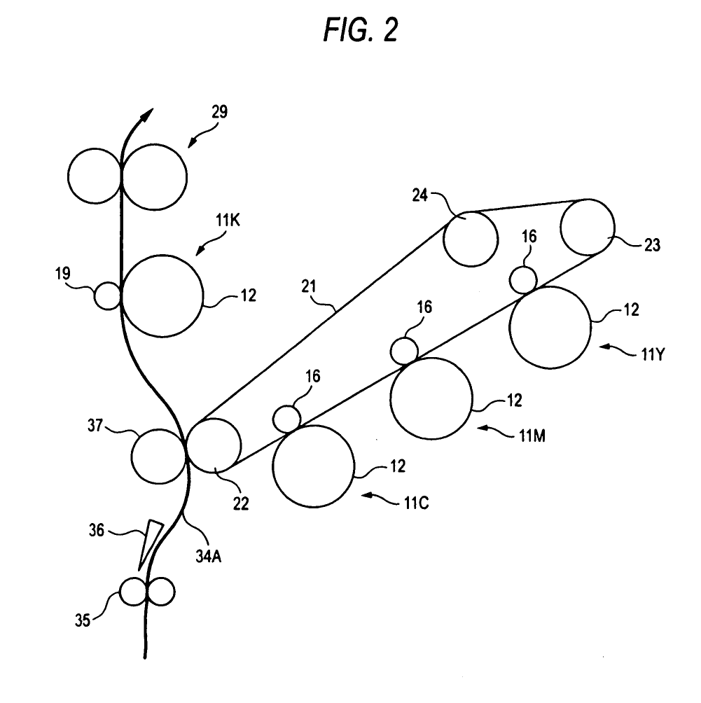

FIG. 2 explains conveyance of a recording medium assumed when a full-color image is formed. When a full-color image is formed, switching of the switching gate 36 allows a recording medium to pass through the first conveying path 34A, as shown in FIG. 2. The recording medium is conveyed with the same timing as the travel of a color image forming unit by the resist roll 35 as a conveying member. With the timing matched, the recording medium reaches a secondary transfer position as a first transfer section (position where the secondary transfer roll 37 comes in contact with the intermediate transfer belt 21). At the secondary transfer position, a press contact force and a predetermined field strength are exercised to sequentially transfer onto the recording medium the toner images transferred onto the intermediate transfer belt 21 in a multiple manner.

In this way, the recording medium onto which the toner images of cyan (C), magenta (M) and yellow (Y) are collectively transferred is conveyed to a direct transfer position (position where the photoreceptor drum 12 comes into contact with the transfer roll 19) and a toner image of black (K) is transferred onto the recording medium by the K image forming unit 11K. That is, the photoreceptor drum 12 of the K image forming unit 11K is electrified at a predetermined potential by the electrifier 13. The exposure device 14 causes a corresponding LED to emit light in accordance with the gradation data input from the IPS 40 and irradiates the light onto the photoreceptor drum 12 via a lens array. In this way, an electrostatic latent image is formed on the surface of the photoreceptor drum 12 through electrification and exposure to light. The formed electrostatic latent image is developed as a toner image of black (K) by the developing device 15 and transferred onto the recording medium by the transfer roll 19.

In this way, a color toner image is transferred by the color image forming unit. Then the recording medium onto which the toner image of black (K) is transferred by the image forming unit 11K undergoes fixing by the fixing device 29, and output as a full-color print.

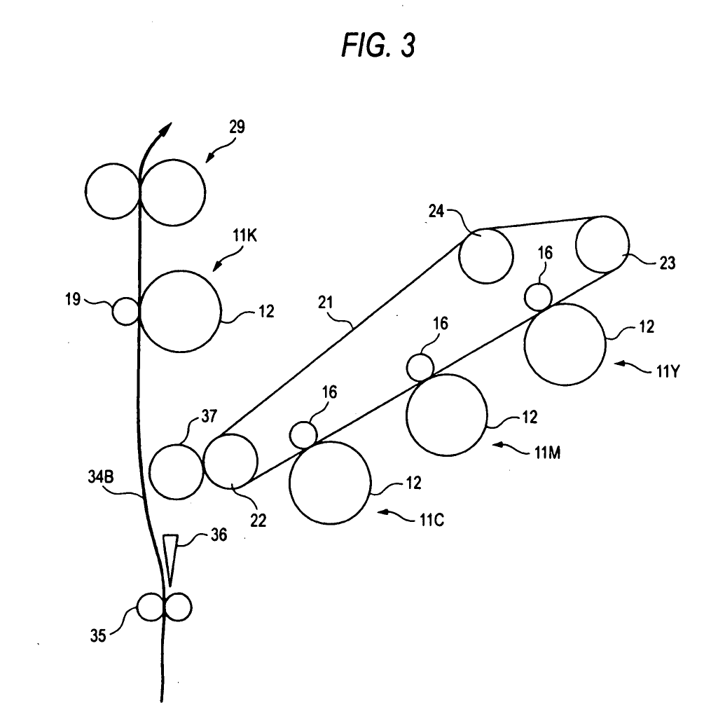

FIG. 3 explains the conveyance of a recording medium when a monochrome image is formed. When a monochrome image is formed, switching of the switching gate 36 allows a recording medium to pass through the second conveying path 34B, as shown in FIG. 3. The second conveying path 34B, unlike the first conveying path 34A shown in FIGS. 1 and 2, does not pass through the image forming section including a color image forming unit as an intermediate transfer mechanism. This recording medium is conveyed by the resist roll 35 with the same timing as the travel of the K image forming unit 11K. By way of the image forming process described above, toner images of black (K) are formed on the photoreceptor drum 12 of the K image forming unit 11K, and the toner images are sequentially transferred onto the recording medium at the direct transfer position where the transfer roll 19 is provided. In this way, when a monochrome image is formed, it is not necessary to operate the color image forming unit. Instead, only the K image forming unit 11K is operated to form a monochrome image.

Control of the image forming apparatus to which this embodiment applies by the controller 50 will be described.

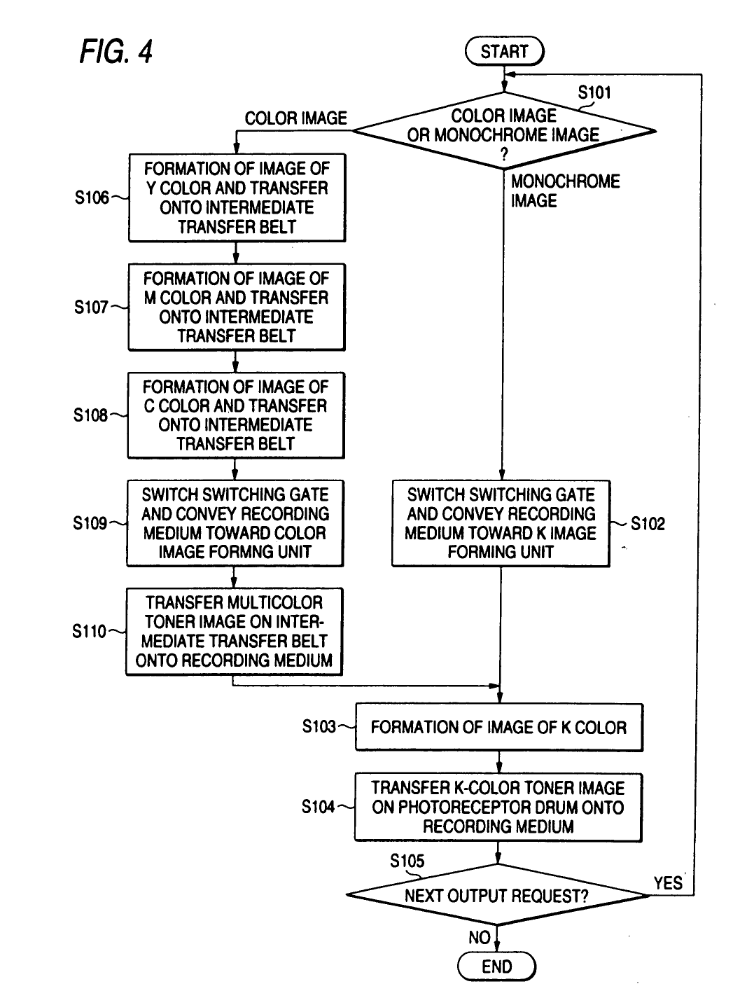

FIG. 4 is a flowchart of the processing for image formation and conveyance of a recording member by way of the controller 50. The controller 50 determines whether the image to be output is a color image or a monochrome image from the image data obtained (input) from the IPS 40 (step 101). In case the image to be output is a monochrome image, the controller 50 switches the switching gate 36 so that the recording medium will not pass through the image forming section including the color image forming unit and instead conveys the recording medium toward the K image forming unit 11K as a direct transfer mechanism (step 102). Before and after this conveyance control, the controller 50 executes formation of an image of color K with predetermined timing (step 103). After that, the controller 50 transfers the K-color toner image on the photoreceptor drum 12 onto the recording medium in synchronization with the recording medium to be conveyed (step 104) and ensures that the recording medium will be output via the fixing device 29. The controller 50 determines whether a next output request is present (step 105). If present, execution returns to step 101. Otherwise, the processing completes.

If the image to be output is determined to be a color image, image formation by the intermediate transfer mechanism (color image forming unit) is executed. That is, the controller 50 starts forming an image of color Y by the image forming unit 11Y and primarily transfers the Y-color toner image carried by the photoreceptor drum 12 onto the intermediate transfer belt 21 (step 106). The controller 50 then starts forming an image of color M by the image forming unit 11M and primarily transfers the M-color toner image carried by the photoreceptor drum 12 onto the Y-color toner image on the intermediate transfer belt 21 (step 107). The controller 50 then starts forming an image of color C by the image forming unit 11C and primarily transfers the C-color toner image carried by the photoreceptor drum 12 onto the Y-color toner image and M-color toner image on the intermediate transfer belt 21 (step 108). Before and after the multiple transfer onto the intermediate transfer belt 21, the controller 50 switches the switching gate 36 so that the recording medium will pass through the image forming section including the color image forming unit and ensures that the recording medium is conveyed (step 109). The controller 50 secondarily transfers the toner image of multiple colors carried onto the intermediate transfer belt 21 onto the recording medium to be conveyed (step 110). Before and after this secondary transfer, in step 103 mentioned above, the controller 50 causes the K image forming unit 11K as a direct transfer mechanism to carry a K-color toner image on the photoreceptor drum 12, and in step 104, transfers the K-color toner image onto the recording medium where a toner image of multiple colors is transferred. The recording medium will then be output via the fixing device 29. Then, same as step 105, it is determined whether there is a next output request. If this is the case, execution returns to step 101. Otherwise, the processing completes.

As detailed above, according to this embodiment, a color image forming unit as an intermediate transfer mechanism and a K image forming unit 11K are separately arranged and toner images are transferred onto a recording medium by way of respective processes to form a full-color image. According to the image forming apparatus to which this embodiment is applied, the K image forming unit 11K of black (K) is completely separated and the image forming units 11Y, 11M, 11C corresponding to yellow (Y), magenta (M), cyan (C) and the associated intermediate transfer belt 21 together form a color image forming unit. This provides dramatically compact and lightweight design of the image forming apparatus with reduced cost, thereby assuring easier maintenance and enhanced reliability. Another major advantage is that the perimeter length of the intermediate transfer belt 21 is substantially reduced such that diameter of the mold is reduced. This enhances the productivity of the intermediate transfer belt.

According to an image forming method to which this embodiment is applied, an image of black (K) is directly transferred onto a recording medium. This improves the transfer efficiency compared with the intermediate transfer system, thus upgrading the picture quality. It is not necessary to consider transfer of the black color (K) in the secondary transfer by way of a color image forming unit. This enhances the setting tolerance range of the secondary transfer voltage, thereby applying a sufficient voltage on the multiple colors of yellow (Y), magenta (M) and cyan (C). Further, transfer failure on hydrous paper or microscopic white spots caused by an excessive current are avoided by the image forming apparatus of the present invention, thus ensuring an accurate image. Another advantage is that the K image forming unit may share technologies with other image forming platforms.

While a toner image is transferred onto a recording medium by the direct transfer mechanism after multiple toner images are transferred by the intermediate transfer mechanism in the full-color image formation shown in FIG. 2, this sequence may be reversed. To be more specific, the black (K) toner image may be transferred by the direct transfer mechanism first, and then the toner images of yellow (Y), magenta (M) and cyan (C) may be transferred by the intermediate transfer mechanism. In this case, the conveying paths shown in FIGS. 2 and 3 are different. A recording medium passes through the direct transfer mechanism used in common between formation of a color image and formation of a monochrome image, and then a gate for switching between the conveying paths is used. In this case, it is preferable that each component be arranged so as not to disturb a toner image formed on the recording medium by way of the gate.

A variant of this embodiment will be described.

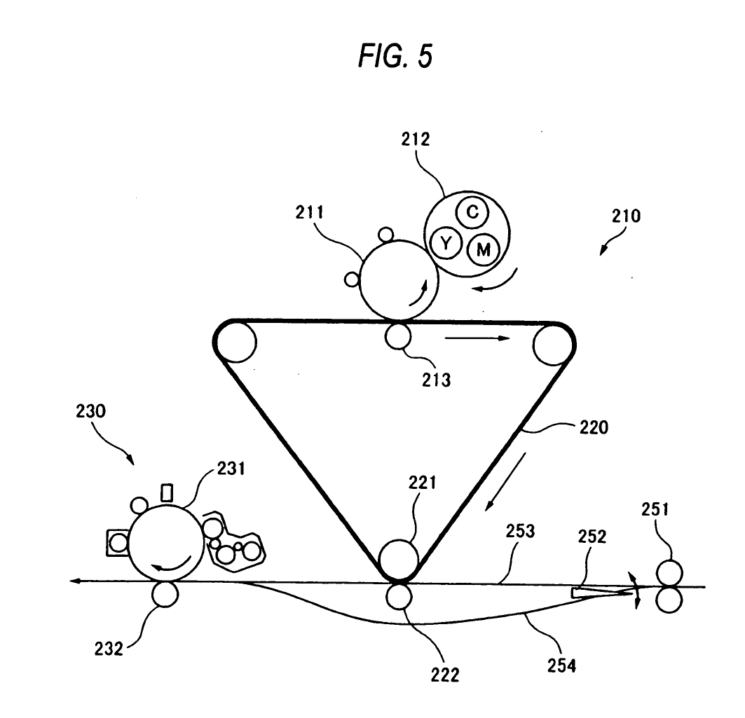

FIG. 5 shows an example where this embodiment is applied to an image forming apparatus of the intermediate transfer system other than the tandem type. The image forming apparatus shown in FIG. 5 comprises an intermediate transfer mechanism 210 for forming color toner images in three cycles and a direct transfer mechanism 230 having a similar configuration to that of the K image forming unit 11K shown in FIG. 1.

The intermediate transfer mechanism 210 includes a photoreceptor drum 211 for carrying a toner image and a rotary developing device 212 that mounts a developing device accommodating toner of yellow (Y), magenta (M) and cyan (C), the rotary developing device 212 rotating about a rotation axis. The intermediate transfer mechanism 210 further includes an intermediate transfer belt 220 arranged in contact with the photoreceptor drum 211, the intermediate transfer belt 220 sequentially carrying toner images of yellow (Y), magenta (M) and cyan (C) to be primarily transferred superimposed on each other, and a primary transfer roll 213 for primarily transferring a toner image onto the intermediate transfer belt 220. The intermediate transfer mechanism 210 further includes a secondary transfer roll 222 provided at the secondary transfer position (first transfer section) on the recording medium conveying path, the secondary transfer roll 222 collectively transferring the toner image carried by the intermediate transfer belt 220. Further, the intermediate transfer mechanism 210 includes a backup roll 221 arranged on the rear surface (inner surface) of the intermediate transfer belt 220 to form a counter electrode facing the secondary transfer roll 222.

The direct transfer mechanism 230 includes a photoreceptor drum 231 for carrying a toner image of black (K) and a transfer roll 232 provided at the direct transfer position (second transfer section) on the recording medium conveying path, the transfer roll 232 transferring the toner image carried on the photoreceptor drum 231.

As a paper conveying system, there are provided a resist roll 251 for temporarily stopping the conveyed recording medium and conveying, with precise timing, the recording medium toward the transfer position (secondary transfer position (first transfer section) or direct transfer position (second transfer section)) of the toner image and a switching gate 252 for switching between the conveying paths (first conveying path 253 or second conveying path 254) for the recording medium conveyed by the resist roll 251.

On the apparatus shown in FIG. 5, in case toner images of a plurality of colors are to be transferred onto a recording medium, a process of forming a toner image on the photoreceptor drum 211 and a process of primarily transferring the toner image is repeated as often as the number of colors. In the example shown in FIG. 5, toner images are formed in the order to yellow (Y), magenta (M) and cyan (C) on the photoreceptor drum 211 in order to superimpose the toner images of three colors, and sequentially undergo primary transfer onto the intermediate transfer belt 220. Meanwhile, the intermediate transfer belt 220 rotates at the same cycle as the photoreceptor drum 211 while holding the yellow (Y) toner image that has undergone primary transfer first. Onto the intermediate transfer belt 220 are superimposed a toner image of magenta (M) and a toner image of cyan (C) at predetermined positions each time the belt makes one turn.

In this way, toner images primarily transferred onto the intermediate transfer belt 220 are conveyed to the secondary transfer position with the rotation of the intermediate transfer belt 220. The recording medium is conveyed with the travel timing of the intermediate transfer mechanism 210 by the resist roll 251 as a conveying member. In this practice, the switching gate 252 is toggled to guide the recording medium to the first conveying path 253. The recording medium is conveyed downstream via the first conveying path 253 and reaches the secondary transfer position as the first transfer section. At the secondary transfer position, a press contact force and a predetermined field strength (secondary transfer bias) are exercised to collectively transfer onto the recording medium the toner images transferred onto the intermediate transfer belt 220 in a multiple manner, followed by sequential transfer in the sub-scan direction (recording medium conveying direction). After that, the recording medium on which the toner images of cyan (C), magenta (M) and yellow (Y) are collectively transferred is conveyed to the direct transfer position as the second transfer section, where a toner image of black (K) is transferred onto the recording medium by the direct transfer mechanism 230. In this way, a toner image of a plurality of colors is formed on a recording medium.

On the apparatus shown in FIG. 5, in case a single-color image is to be transferred onto a recording medium, the switching gate 252 is toggled so that the recording medium will pass through the second conveying path 254. The second path 254, unlike the first conveying path 253 shown, does not pass through the secondary transfer position of the intermediate transfer mechanism 210. The recording medium is conveyed by the resist roll 251 with the same timing as the travel of the direct transfer mechanism 230. That is, a toner image of black (K) is formed on the photoreceptor drum 231 of the direct transfer mechanism 230 by way of the most general single-color image forming process and the toner image is sequentially transferred onto a recording medium at the direct transfer position including the transfer roll 232. In this way, when a monochrome image is formed, it is not necessary to operate the intermediate transfer mechanism 210 as a color image forming unit. Instead, only the direct transfer mechanism 230 as a single-color image forming unit is operated to form a monochrome image.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
an intermediate transfer mechanism that carries a toner image on an intermediate transfer body and then transfers the toner image onto a recording medium;
a direct transfer mechanism that directly transfers the toner image onto a recording medium; and
a controller that controls printing using the direct transfer mechanism alone or using both the intermediate transfer mechanism and the direct transfer mechanism, depending on the type of an image to be printed.

2. (canceled)

3. (canceled)

4. (canceled)

5. An image forming apparatus comprising:
an intermediate transfer mechanism that carries a toner image on an intermediate transfer body and then transfers the toner image onto a recording medium; and
a direct transfer mechanism that directly transfers the toner image onto a recording medium,
wherein the image forming apparatus outputs a single image print by using both the intermediate transfer mechanism and the direct transfer mechanism.

6. (canceled)

7. (canceled)

8. (canceled)

9. An image forming apparatus comprising:
a first transfer mechanism that transfers an image of a plurality of colors onto a recording medium;
a second transfer mechanism that transfers a single-color image onto the recording medium;
a first conveying path that conveys the recording medium via both the first transfer mechanism and the second transfer mechanism and that forms the image onto the recording medium; and
a second conveying path that conveys the recording medium via the second transfer mechanism and not the first transfer mechanism and that forms the image onto the recording medium.

10. (canceled)

11. (canceled)

12. (canceled)

13. (canceled)

14. An image forming method, comprising:
determining whether an image to be output is a color image or a monochrome image based on an input image data; and
conveying a recording medium is conveyed via a first image forming unit for forming a black color (K) image without passing through a second image forming unit for forming an image including a plurality of colors, when it is determined that the monochrome image is outputted; and
conveying the recording medium is conveyed via both the first image forming unit and the second image forming unit, when it is determined that the image is a color image.

15. (canceled)

16. (canceled)

17. An image forming apparatus comprising:
an intermediate transfer mechanism that carries a toner image on an intermediate transfer body and then transfers the toner image onto a recording medium;
a direct transfer mechanism that directly transfers the toner image onto a recording medium; and
a controller that controls printing using the direct transfer mechanism alone or using both the intermediate transfer mechanism and the direct transfer mechanism, depending on the type of image to be printed,
wherein the direct transfer by the direct transfer mechanism is performed before the intermediate transfer by the intermediate transfer mechanism.

18. An image forming apparatus comprising:
an intermediate transfer mechanism that carries a toner image on an intermediate transfer body and then transfers the toner image onto a recording medium; and
a direct transfer mechanism that directly transfers the toner image onto a recording medium,
wherein the image forming apparatus outputs a single image print by using both the intermediate transfer mechanism and the direct transfer mechanism, and the direct transfer by the direct transfer mechanism is performed before the intermediate transfer by the intermediate transfer mechanism.

19. An image forming apparatus comprising:
a first transfer mechanism that transfers an image of a plurality of colors onto a recording medium;
a second transfer mechanism that transfers a single-color image onto the recording medium;
a first conveying path that conveys the recording medium via both the first transfer mechanism and the second transfer mechanism and that forms the image onto the recording medium; and
a second conveying path that conveys the recording medium via the second transfer mechanism and not the first transfer mechanism and that forms the image onto the recording medium,
wherein the recording medium is conveyed via the second transfer mechanism before the first transfer mechanism in the first conveying path.

20. An image forming method, comprising:
determining whether an image to be output is a color image or a monochrome image based on an input image data; and
conveying a recording medium via a first image forming unit for forming a black color (K) image without passing through a second image forming unit for forming an image including a plurality of colors, when it is determined that the monochrome image is outputted; and
conveying the recording medium via both the first image forming unit and the second image forming unit, when it is determined that the image is a color image,
wherein the recording medium is conveyed via the first image forming unit before the recording medium is conveyed via the second image forming unit when it is determined that the image is a color image.

21. An image forming apparatus comprising:
an intermediate transfer mechanism that carries a toner image on an intermediate transfer body and then transfers the toner image onto a recording medium;
a direct transfer mechanism that directly transfers the toner image onto a recording medium; and
a controller that controls printing using the direct transfer mechanism alone or using both the intermediate transfer mechanism and the direct transfer mechanism, depending on the type of an image to be printed,
wherein the intermediate transfer mechanism comprises a rotary developing device.

22. An image forming apparatus comprising:
a first transfer mechanism that transfers an image of a plurality of colors onto a recording medium;
a second transfer mechanism that transfers a single-color image onto the recording medium;
a first conveying path that conveys the recording medium via both the first transfer mechanism and the second transfer mechanism and that forms the image onto the recording medium; and
a second conveying path that conveys the recording medium via the second transfer mechanism and not the first transfer mechanism and that forms the image onto the recording medium,
wherein the first transfer mechanism comprises a rotary developing device.

23. An image forming method, comprising:
determining whether an image to be output is a color image or a monochrome image based on an input image data; and
conveying a recording medium via a first image forming unit for forming a black color (K) image without passing through a second image forming unit for forming an image including a plurality of colors, when it is determined that the monochrome image is outputted; and
conveying the recording medium via both the first image forming unit and the second image forming unit, when it is determined that the image is a color image,
wherein the second image forming unit comprises a rotary developing device.
